(19) United States
(12) Patent Application Publication
(10) Pub. No.: US 2010/0271277 A1
(43) Pub. Date: Oct. 28, 2010

(54) Slot Antenna

(75) Inventors: Yu-Chang Kao, Taipei County (TW); Hua-Ming Chen, Taipei County (TW); Yang-Kai Wang, Taipei County (TW); Yi-Fang Lin, Taipei County (TW); Chien-Hung Chen, Taipei County (TW); Ya-Ping Chen, Taipei County (TW)

Correspondence Address: THE MUELLER LAW OFFICE, P.C., 12951 Harwick Lane, San Diego, CA, 92130, US

(73) Assignee: Advanced Connection Technology Inc., Taipei County (TW)

(21) Appl. No.: 12/546,685

(22) Filed: Aug. 25, 2009

(30) Foreign Application Priority Data
Apr. 28, 2009 (TW) 098114018

(51) Int. Cl. H01Q 13/10

(52) U.S. Cl. 343/767

(57) ABSTRACT

A slot antenna includes a dielectric substrate, and an antenna body that is formed on the dielectric substrate. The antenna body defines an open loop antenna slot that has first and second ends, and an open loop perturbation slot that extends inwardly from the open loop antenna slot, and that has first and second ends, each of which is connected to a respective one of the first and second ends of the open loop antenna slot.

### CROSS-REFERENCE TO RELATED APPLICATION

This application claims priority of Taiwanese application no. 098114018, filed on Apr. 28, 2009.

### BACKGROUND OF THE INVENTION

1. Field of the Invention

This invention relates to an antenna, more particularly to a slot antenna.

2. Description of the Related Art

Circularly polarized antennas are omnidirectional, mitigate Faraday Effect and multipath fading, and thus are suitable for application in technologies such as radio frequency identification (RFID), global positioning system (GPS), and wireless local area network (WLAN). A conventional circularly polarized slot antenna includes an open loop antenna slot, and a perturbation slot that extends inwardly from the open loop antenna slot and that is rectangular in shape.

The aforementioned conventional circularly polarized slot antenna is disadvantageous in that, since the perturbation slot thereof has a relatively large width, the conventional circularly polarized slot antenna has insufficient gain and axial ratio bandwidth and is difficult to adjust to a desired circularly polarized wave.

### SUMMARY OF THE INVENTION

Therefore, the object of the present invention is to provide a slot antenna that can overcome the aforesaid drawbacks of the prior art.

According to the present invention, a slot antenna comprises a dielectric substrate and an antenna body. The antenna body is formed on the dielectric substrate, and defines an open loop antenna slot that has opposite first and second ends, and an open loop perturbation slot that extends inwardly from the open loop antenna slot, and that has opposite first and second ends, each of which is connected to a respective one of the first and second ends of the open loop antenna slot.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of a slot antenna according to the present invention;

FIG. 2 is a schematic view illustrating a dielectric substrate of the preferred embodiment;

FIGS. 3 and 4 are schematic views illustrating dimensions of the preferred embodiment in millimeter;

FIG. 5 is a plot illustrating a return loss of the preferred embodiment;

FIG. 6 is a smith chart illustrating a voltage standing wave ratio (VSWR) of the preferred embodiment;

FIG. 7 shows a plot of a radiation pattern of the preferred embodiment on the x-z plane when operated at 915 MHz;

FIG. 8 shows a plot of a radiation pattern of the preferred embodiment on the y-z plane when operated at 915 MHz;

FIG. 9 is a plot illustrating an axial ratio of the preferred embodiment; and

FIG. 10 is a plot illustrating a gain of the preferred embodiment.

### DETAILED DESCRIPTION OF THE PREFERRED EMBODIMENT

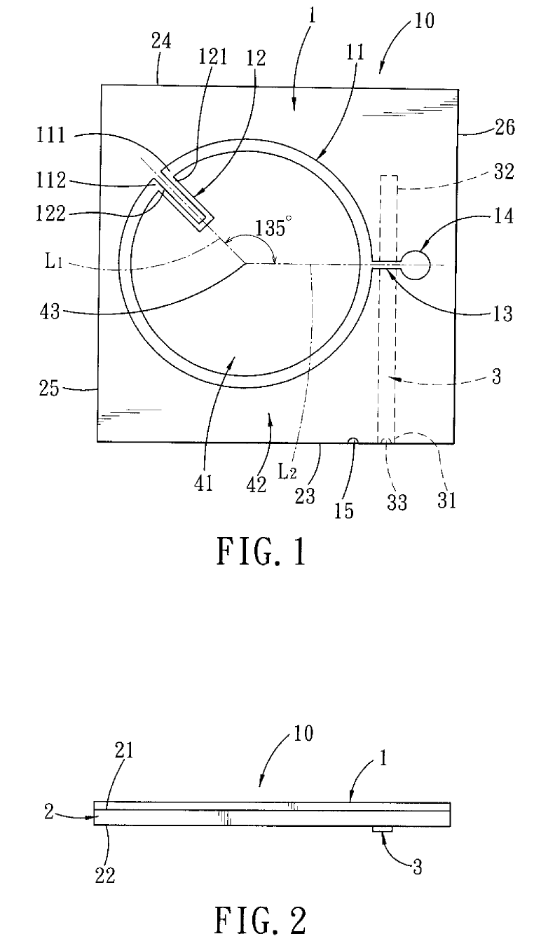

Referring to FIGS. 1 and 2, the preferred embodiment of a slot antenna 10 according to this invention is shown to include a dielectric substrate 2 and an antenna body 1.

The slot antenna 10 of this invention operates in a radio frequency identification (RFID) ultra high frequency (UHF) range from 902 MHz to 928 MHZ, and has a low profile, as illustrated in FIG. 4.

The dielectric substrate 2 has opposite first and second surfaces 21, 22, is generally square in shape, and has four sides 23, 24, 25, 26. Moreover, in this embodiment, the dielectric substrate 2 is made of FR4.

In some embodiments, the dielectric substrate 2 is made from a ceramic material.

The antenna body 1 is formed on the first surface 21 of the dielectric substrate 2, is a conductive foil, defines an open loop antenna slot 11, an open loop perturbation slot 12, a coupling slot 13, and an impedance matching slot 14, and has inner and outer regions 41, 42.

The open loop antenna slot 11 has opposite first and second ends 111, 112. In this embodiment, the open loop antenna slot 11 has a constant radius of curvature.

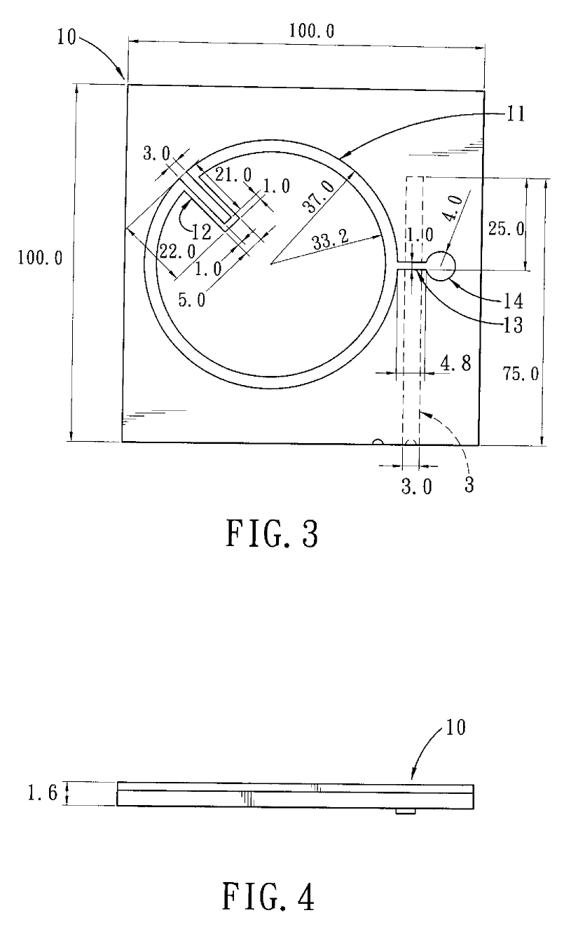

The open loop perturbation slot 12 extends radially and inwardly from the open loop antenna slot 11, and has opposite first and second ends 121, 122, each of which is connected to a respective one of the first and second ends 111, 112 of the open loop antenna slot 11. In this embodiment, the open loop perturbation slot 12 is generally U-shaped. Moreover, in this embodiment, the open loop perturbation slot 12 has a narrow width, as illustrated in FIG. 3.

It is noted that the open loop perturbation slot 12 provides two orthogonal resonant modes that are excited in equal amplitude and that are 90° out of phase, thereby permitting the slot antenna 10 of this invention to radiate a circularly polarized wave.

The outer region 42 surrounds the open loop antenna slot 11, and has four sides, each of which is flush with a respective one of the sides 23, 24, 25, 26 of the dielectric substrate 2.

The slot antenna 10 further includes a grounding point 15 provided in the outer region 42 and disposed proximate to the side 23 of the dielectric substrate 2.

The coupling slot 13 extends radially and outwardly from the open loop antenna slot 11 at a position between the first and second ends 111, 112 of the open loop antenna slot 11, is generally rectangular in shape, and has a distal end distal from the open loop antenna slot 11.

The inner region 41 is defined by the open loop antenna slot 11 and has a center 43.

The antenna body 1 further defines a first imaginary straight line (L₁) that passes through the open loop perturbation slot 12 and the center 43 of the inner region 41, and a second imaginary straight line (L₂) that passes through the coupling slot 13 and the center 43 of the inner region 41. In this embodiment, the first and second imaginary straight lines (L₁, L₂) define therebetween a 135°-degree angle, thereby permitting the slot antenna 10 to radiate a right-hand circularly polarized wave.

In an alternative embodiment, the first and second imaginary straight lines (L₁, L₂) define therebetween a 45°-degree angle or a 225°-degree angle, thereby permitting the slot antenna 10 to radiate a left-hand circularly polarized wave.

In yet another embodiment, the first and second imaginary straight lines (L₁, L₂) define therebetween an angle such that the slot antenna 10 radiates an elliptically polarized wave.

The slot antenna 10 further includes a feeding element 3 formed on the second surface 22 of the dielectric substrate 2. The feeding element 3 is in the form of a microstrip line, and has opposite first and second ends 31, 32 that are respectively proximate to and distal from the side 23 of the dielectric substrate 2.

In this embodiment, the coupling slot 13 and the feeding element 3 overlap each other. Moreover, in this embodiment, the coupling slot 13 and the feeding element 3 are transverse to each other. Further, in this embodiment, the open loop perturbation slot 12 and the first end 31 of the feeding element 3 define a first distance therebetween, and the open loop perturbation slot 12 and the second end 32 of the feeding element 3 define a second distance therebetween less than the first distance.

The slot antenna 10 further includes a feeding point 33 provided on the first end of the feeding element 3.

It is noted that signals are fed to the slot antenna 10 through the feeding element 3 via the feeding point 33.

The impedance matching slot 14 is disposed in the outer region 42 and extends from the distal end of the coupling slot 13. In this embodiment, the impedance matching slot 14 is generally circular in shape.

It is noted that the impedance matching slot 14 operates as an open stub and is used for impedance matching of the slot antenna 10.

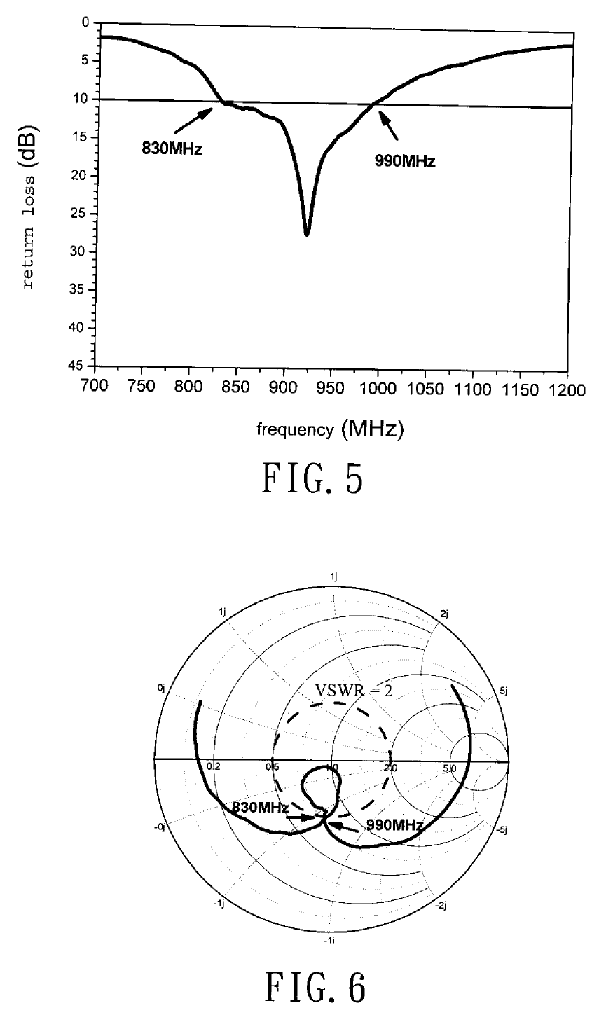

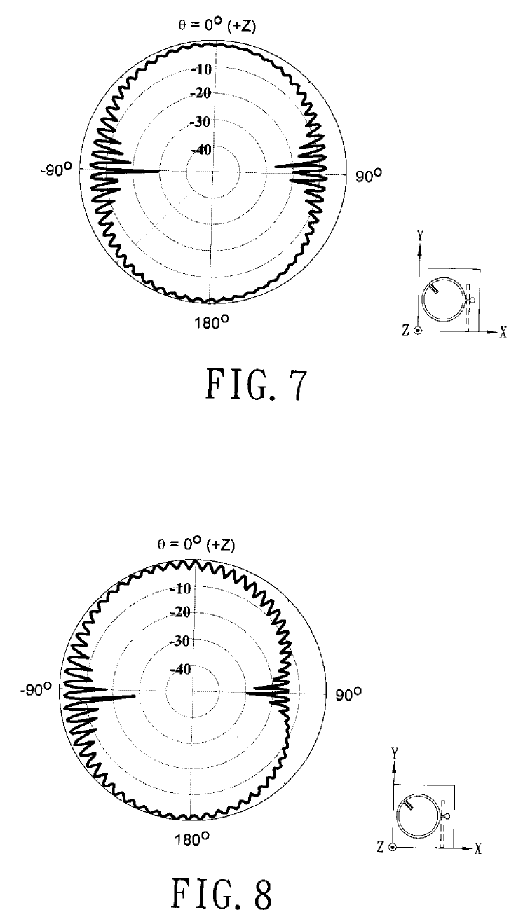

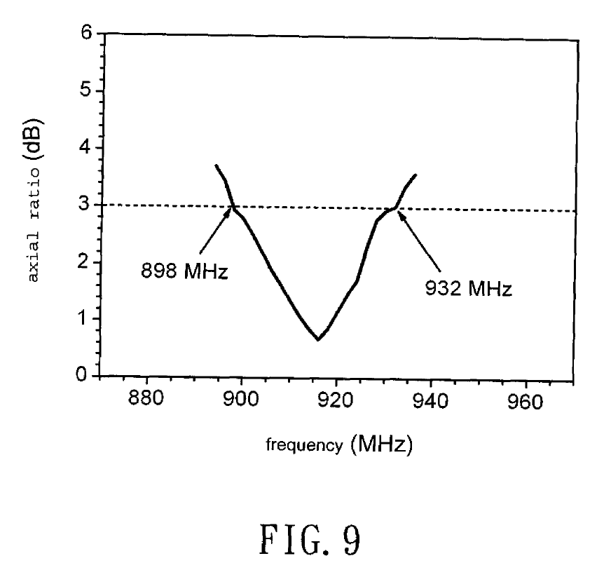

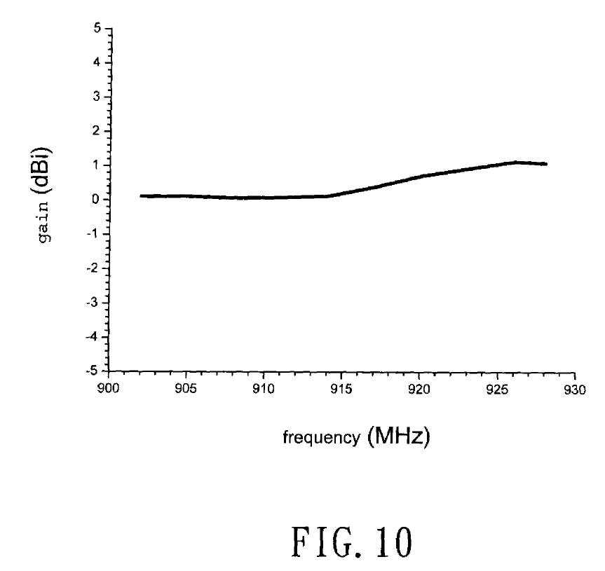

Based from experimental results, as illustrated in FIGS. 5 and 6, the slot antenna 10 of this invention, when operated in the frequency range from 830 MHz to 990 MHz, achieves a return loss of less than 10 dB and a voltage standing wave ratio (VSWR) of 2.0, respectively. Moreover, as illustrated in FIGS. 7 and 8, the slot antenna 10 of this invention, when operated at 915 MHz, has a 3 dB beamwidth of 100° and 50°, respectively. These indicate that the slot antenna 10 of this invention has a substantially omnidirectional radiation pattern when operated at 915 MHz. Further, as illustrated in FIG. 9, the slot antenna 10 of this invention, when operated in the frequency range from 898 MHz to 932 MHz, achieves an axial ratio of less than 3 dB and an axial ratio bandwidth of 3.72%. Still further, as illustrated in FIG. 10, the slot antenna 10 of this invention, when operated in the RFID UHF range, has a gain that varies between 0 to 1.5 dBi. This indicates that the slot antenna 10 of this invention has a stable transmission and reception efficiencies when operated in the RFID UHF range.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A slot antenna, comprising:
a dielectric substrate; and
an antenna body formed on said dielectric substrate, said antenna body defining an open loop antenna slot that has opposite first and second ends, and an open loop perturbation slot that extends inwardly from said open loop antenna slot, and that has opposite first and second ends, each of which is connected to a respective one of said first and second ends of said open loop antenna slot.

2. The slot antenna as claimed in claim 1, wherein said open loop perturbation slot is generally U-shaped.

3. The slot antenna as claimed in claim 1, wherein said open loop perturbation slot extends radially from said open loop antenna slot.

4. The slot antenna as claimed in claim 1, wherein said open loop antenna slot has a constant radius of curvature.

5. The slot antenna as claimed in claim 1, wherein said antenna body has an outer region that surrounds said open loop antenna slot,
said slot antenna further comprising a grounding point provided in said outer region.

6. The slot antenna as claimed in claim 1, wherein said antenna body further defines a coupling slot that extends outwardly from said open loop antenna slot at a position between said first and second ends of said open loop antenna slot.

7. The slot antenna as claimed in claim 6, wherein said antenna body has an inner region that is defined by said open loop antenna slot and that has a center,
said antenna body further defining a first imaginary straight line that passes through said open loop perturbation slot and said center of said inner region, and a second imaginary straight line that passes through said coupling slot and said center of said inner region, the first and second imaginary straight lines defining therebetween one of 135°-degree angle, 45°-degree angle, and 225°-degree angle.

8. The slot antenna as claimed in claim 6, wherein said coupling slot extends radially from said open loop antenna slot.

9. The slot antenna as claimed in claim 6, wherein said coupling slot is generally rectangular in shape.

10. The slot antenna as claimed in claim 6, wherein said coupling slot has a distal end distal from said open loop antenna slot,
said antenna body further defines an impedance matching slot that extends from said distal end of said coupling slot.

11. The slot antenna as claimed in claim 10, wherein said dielectric substrate has opposite first and second surfaces,
said open loop antenna slot, said open loop perturbation slot, said coupling slot, and said impedance matching slot being disposed on said first surface of said dielectric substrate,
said slot antenna further comprising a feeding element formed on said second surface of said dielectric substrate.

12. The slot antenna as claimed in claim 11, wherein said dielectric substrate has a side,
said feeding element having opposite first and second ends that are respectively disposed proximate to and distal from said side of said dielectric substrate,
said open loop perturbation slot and said first end of said feeding element defining a first distance therebetween,
said open loop perturbation slot and said second end of said feeding element defining a second distance therebetween less than the first distance.

13. The slot antenna as claimed in claim 11, wherein said coupling slot and said feeding element overlap each other.

14. The slot antenna as claimed in claim 11, wherein said coupling slot and said feeding element are transverse to each other.

15. The slot antenna as claimed in claim 11, wherein said feeding element is in the form of a microstrip line.
